(19) United States
(12) Patent Application Publication
(10) Pub. No.: US 2019/0251073 A1
(43) Pub. Date: Aug. 15, 2019

(54) METHOD AND INTERACTIVE DEVICE FOR PROVIDING SOCIAL INTERACTION

(71) Applicant: Samsung Electronics Co., Ltd., Gyeonggi-do (KR)

(72) Inventors: Shashanka Dasari, Bangalore (IN); Anand Sudhakar Chiddarwar, Nagpur (IN); Mugula Satya Shankar Kameshwar Sharma, Bangalore (IN); Prathyush Kalashwaram, Bangalore (IN); Rahul Vaish, Bangalore (IN)

(73) Assignee: Samsung Electronics Co., Ltd.

(21) Appl. No.: 16/267,985

(22) Filed: Feb. 5, 2019

(30) Foreign Application Priority Data
Feb. 14, 2018 (IN) 201841005607

(51) Int. Cl. G06F 16/23; G06F 16/28

(52) U.S. Cl. CPC G06F 16/2365; G06F 16/285

(57) ABSTRACT

A method of providing social interaction by an interactive device is provided. The method includes receiving identification information associated with a user and obtaining a user profile from one or more devices in an environment using the identification information by detecting the one or more devices in proximity to the interactive device. The method also includes identifying a relationship between the user and one or more members in the environment from the user profile and creating a relationship profile related to the user with the one or more members based on the identified relationship. Additionally, the method includes interacting with the user and the one or more members by performing one or more actions by analyzing the relationship profile.

### CROSS-REFERENCE TO RELATED APPLICATION(S)

This application is based on and claims priority under 35 U.S.C. § 119 to Indian Patent Complete Application No. 201841005607, filed on Feb. 14, 2018, in the Indian Patent Office, the disclosure of which is incorporated by reference herein in its entirety.

### BACKGROUND

### 1. Field of the Disclosure

The disclosure relates generally to interactive devices, and more particularly to a method and interactive device for providing social interaction.

### 2. Description of the Related Art

In general, interactive devices have become an integral part of day to day life. Initially interactive devices (e.g., service robots) which performed a specific task were introduced, for tasks such as moving heavy objects. Later, interactive devices were enhanced to be integrated into various social environments, such as a workplace environment and a home environment.

Generally, a socially interactive device has a standard interaction pattern towards all users in the social environment who interact with the socially interactive device. Such a standard interaction pattern, without any consideration of context in interactions with each user in the social environment, hinders the integration of the interactive device into the social environment. For example, interactions of the interactive device with an elderly person and a child are the same.

To integrate the interactive device into the social environment, a process of on-boarding the interactive device is implemented. On-boarding the interactive device in the social environment can include various steps including but not limited to providing details pertaining to the users in the social environment. The interactive device can also be provided with information indicative of other devices in the social environment. For example, to integrate the interactive device in a household, information pertaining to members of the household and information pertaining to objects and devices in the household must be provided to the interactive device. Further, if any communication network such as a wireless fidelity (Wi-Fi) network or an Internet of things (IoT) network is operational in the household, information pertaining to the communication network or the IoT network needs to be provided to the interactive device to facilitate integration. Typically, the process of on-boarding the interactive device includes multiple steps and has to be done manually by the user. Further, the process of storing various information pertaining to members of the household, objects in the household, the operational networks are performed manually, which makes the on-boarding process cumbersome. Accordingly, there remains a need for better methods of on-boarding the interactive device to provide social interaction between the users and the interactive device.

### SUMMARY

The disclosure has been made to address the above-mentioned problems and disadvantages, and to provide at least the advantages described below.

In accordance with an aspect of the disclosure, a method of providing social interaction by an interactive device is provided. The method includes receiving identification information associated with a user and obtaining a user profile from one or more devices in an environment using the identification information by detecting the one or more devices in proximity to the interactive device. The method also includes identifying a relationship between the user and one or more members in the environment from the user profile. Further, the method includes generating a relationship profile related to the user with the one or more members based on the identified relationship. Additionally, the method includes interacting with the user and the one or more members by performing one or more actions by analyzing the relationship profile.

In accordance with another aspect of the disclosure, an interactive device is provided. The interactive device includes a memory and a processor coupled to the memory. The processor is configured to receive identification information associated with a user and obtain a user profile from one or more devices in an environment using the identification information by detecting the one or more devices in proximity to the interactive device. The processor is also configured to identify a relationship between the user and one or more members in the environment from the user profile. Further, the processor is also configured to generate a relationship profile related to the user with the one or more members based on the identified relationship. Additionally, the profile manager is configured to interact with the user and the one or more members by performing one or more actions by analyzing the relationship profile.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a block diagram illustrating various hardware components of an interactive device for providing social interaction, according to an embodiment;

FIG. 1B is a schematic diagram illustrating interaction between the various hardware components of the interactive device for providing social interaction, according to an embodiment;

FIG. 2 is a flow chart illustrating a method of providing social interaction by the interactive device, according to an embodiment;

FIG. 3A is a flow chart illustrating a method for on-boarding the interactive device and creating a user profile, according to an embodiment;

FIG. 3B is a flow chart illustrating a method for automatically on-boarding one or more members related to the user in an environment of the interactive device, according to an embodiment;

FIG. 3C is a flow chart illustrating a method for adding a new member identified by the interactive device to a relationship tree, according to an embodiment;

FIG. 3D is a flow chart illustrating a method for adding the new member to the relationship tree based on an introduction of the new member, according to an embodiment;

FIG. 4 illustrates a method for on-boarding the interactive device and creating the user profile, according to an embodiment;

FIG. 5 illustrates a method for creating profiles for the one or more members related to the user, according to an embodiment;

FIG. 6A illustrates a method for creating a relationship profile for a family of the user, according to an embodiment;

FIG. 6B illustrates profiles for a family of the user, according to an embodiment;

FIG. 7 illustrates a method for the user to request the interactive device to play music, according to an embodiment;

FIG. 8 illustrates a method for the interactive device to help the members discover a restaurant based on a conversation, according to an embodiment;

FIG. 9A illustrates a first method for providing the mannerism of the interactive device, according to an embodiment;

FIG. 9B illustrates a second method for providing the mannerism of the interactive device, according to an embodiment; and

FIG. 10 illustrates a method for generating a map of an environment by the interactive device, according to an embodiment.

### DETAILED DESCRIPTION OF INVENTION

Various embodiments of the disclosure are described with reference to the accompanying drawings. It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements.

Also, the various embodiments described herein are not necessarily mutually exclusive, as some embodiments can be combined with one or more other embodiments to form new embodiments.

As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

As is traditional in the field, embodiments may be described and illustrated in terms of blocks which carry out a described function or functions. These blocks, which may be referred to herein as units, engines, managers, or modules, are physically implemented by analog and/or digital circuits such as logic gates, integrated circuits, microprocessors, microcontrollers, memory circuits, passive electronic components, active electronic components, optical components, and hardwired circuits, and may optionally be driven by firmware and/or software. The circuits may, for example, be embodied in one or more semiconductor chips, or on substrate supports such as printed circuit boards. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block may be physically separated into two or more interacting and discrete blocks without departing from the scope of the disclosure. Likewise, the blocks of the embodiments may be physically combined into more complex blocks without departing from the scope of the disclosure.

Accordingly, a method of providing social interaction by an interactive device is provided. The method includes receiving identification information associated with a user and obtaining a user profile from one or more devices in an environment using the identification information by detecting the one or more devices in proximity to the interactive device. The method also includes identifying a relationship between the user and one or more members in the environment from the user profile. Further, the method includes generating a relationship profile related to the user with the one or more members based on the identified relationship. Additionally, the method includes interacting with the user and the one or more members by performing one or more actions by analyzing the relationship profile.

According to an embodiment, interacting with the user and the one or more members by performing one or more actions by analyzing the relationship profile includes detecting a presence of at least one human in proximity to the interactive device based on at least one of listening to the human by capturing audio, capturing video, viewing the human, or receiving a physical contact by the human; analyzing at least one of the captured audio, the captured video, the viewed human and the received physical contact based on the relationship profile; and performing one or more actions in response to the analysis.

The method also includes continuously updating the profile of the user and one or more members by analyzing the at least one of the captured audio, the captured video, the viewed human or the received physical contact based on the relationship profile and interacting with the user and the one or more members based on the updated profile of the one or more members.

Interacting with the user and the one or more members further includes obtaining one or more images of the environment and generating a map of the environment using the obtained images. Further, the method includes receiving one or more commands from one of the user and the one or more members and identifying the one or more devices operable to be controlled in the environment. Additionally, the method includes controlling one or more devices based on the one or more commands.

The one or more images of the environment are analyzed to classify the environment into one or more zones, wherein the one or more zones are classified by identifying one or more activities of the user and the one or more members in the one or more zones.

The method also includes creating a profile for one or more new members detected in the environment by interacting with the one or more new members and dynamically updating the relationship profile using the profile of the one or more new members. Further, the method also includes interacting with the one or more new members by performing one or more actions based on the relationship profile and by listening to the one or more new members.

The method provides for on-boarding of the interactive device and associating the interactive device to the particular user in a single step using the identification information of the user.

Additionally, the interactive device organizes the devices present in the environment based on identification information of the user and associates the user and the devices to various rooms based on monitoring the behavior of the user.

In addition, the interactive device learns the mannerism of the user with the other members present in the environment and acts accordingly. Hence, the interactive device provides dynamic interactions and builds a personality of its own based on the learning.

Further, the interactive device generates a common relationship profile in addition to the individual user profiles and takes the environment into consideration to perform some action. For example, when a user is alone and requests the interactive device to play a song, the interactive device plays the user's favorite song based on different context like time of day, weather, occasion etc. When the user is with other family members and requests the interactive device to play a song, the interactive device plays a song from the common relationship profile derived for multiple context values.

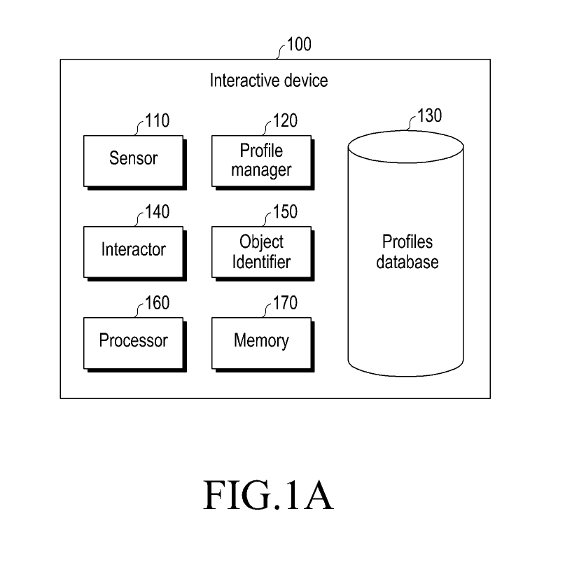

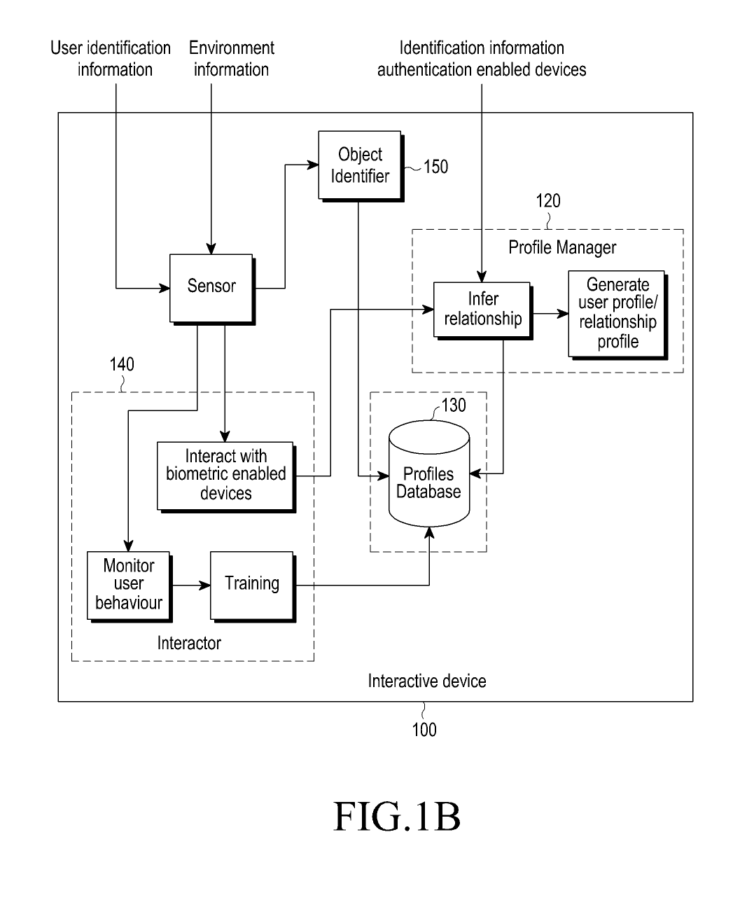

FIG. 1A is a block diagram illustrating various hardware components of the interactive device 100 for providing social interaction, according to an embodiment.

Referring to the FIG. 1A, the interactive device 100 can include a sensor 110, a profile manager 120, a profiles database 130, an interactor 140, an object identifier 150, a processor 160 and a memory 170. The sensor 110, the profile manager 120, the profiles database 130, the interactor 140, the object identifier 150, the processor 160 and the memory 170 are coupled to each other.

The interactive device 100 can be any interactive device such as but not limited to a robot, a mobile phone, a smart phone, personal digital assistants (PDAs), a tablet, a wearable device, and a smart speaker.

The sensor 110 can be a combination of various sensors. For example the sensor 110 can include identification sensors for identification detection, which may include any mechanism of detecting an identity of the user, such as iris recognition, facial recognition, speech recognition, touch recognition, and fingerprint recognition; proximity detection; detecting using passwords; or detecting using secret keys with encryption. Further, the sensor 110 can also include inertial sensors such as an accelerometer, a gyroscope and a magnetoscope which help the interactive device 100 navigate in a given environment, provide obstacle detection, or provide collision detection. Furthermore, the sensor 110 can also include sensors for gesture recognition and mood sensing. The sensor 110 may also include a camera for capturing images and videos of the user environment. The sensor 100 can also be configured to receive commands where the commands can be in the form of a voice, a gesture, and a touch.

Further, the sensor 110 can also be configured to detect the presence of the one or more devices enabled for identification information based authentication in proximity to the interactive device 100 and determine whether the user identification information matches the identification information of the one or more devices enabled for identification authentication in proximity to the interactive device 100. For example, the interactive device 100 may have face recognition sensors which capture the user's face (i.e., the identification information). The identification information is advertised to face recognition authentication enabled devices which are in proximity to the interactive device 100 to determine the presence of the face recognition authentication enabled devices, which use the particular user's face as the identification information for authenticating and providing access to the device.

Upon determining that the identification information matches the identification information of the one or more devices, the one or more devices are unlocked and the interactive device 100 gains access to the one or more devices.

The profile manager 120 can be configured to access and obtain the basic user profile information from the one or more devices detected in proximity to the interactive device 100. Further, the user profile information obtained from the one or more devices may be used to build the user profile which comprises information related to the user, such as the user's personal details, account details, social media data, favorite music, favorite food, or interests (i.e., sports).

Further, the profile manager 120 can also be configured to deduce the relationship between the user (i.e., the owner of the interactive device 100) and one or more members who are present in the environment. The relationship between the user and the one or more members present in the environment may be deduced based on the user profile information obtained from one of the devices and social media, accessed using the identification information as the key. Further, the profile manager 120 also creates profiles of the one or more members present in the environment and dynamically updates the relationship profile.

Furthermore, the profile manager 120 can also be configured to create a relationship profile (e.g., a common profile containing relationship details like husband-wife, brother-sister, friends, and teams, based on the environment) related to the user with the one or more members by determining common characteristics among the user and the one or more members.

The profile manager 120 can be configured to generate a map of the environment using the images captured by the sensor 110. Further, the images of the environment may be analyzed to classify the environment into one or more zones. The zones may be classified by monitoring the activities of the user and the one or more members with respect to the zones.

The profiles database 130 may store user profiles for multiple users. The profiles generated by the profile manager 120 (i.e., the user profile, the profiles of the one or more members and the relationship profile) may be stored in the profiles database 130 and accessed by the profile manager 120 based on the requirements. The user profile may include user profile information such as the name, age, family, contacts, friends, the user's likes, and the user's favorites.

The interactor 140 can be configured to monitor the behavior of the user and the one or more members related to the user over a period of time. The interactor 140 may learn the behavior of the user with respect to the social environment, such as the area in which a particular user spends more time and the environmental conditions preferred by the particular user. Further, the interactor 140 can also be configured to update the profiles of the user and the one or more members, which are stored in the profiles database 130 based on the learning. The learning of the environment may be performed by analyzing at least one of a captured audio or a captured video. The interactor 140 can also be configured to intelligently analyze and interpret the parameters detected by the sensor 110.

For example, member A may spend most of the time in the study room and prefer the temperature to be around 23° C. The interactor 140 may learn the temperature preferences of the member A and interact with a thermostat present in the study room to regulate the temperature in the presence of the member A.

Further, the interactive device 100 may also build up a personality of its own based on learned information provided by the interactor 140, which helps the interactive device 100 provide enhanced social interaction and integrate into the environment which includes the user and the one or more members. For example, when the interactive device 100 is used in an office environment, the interactor 140 may learn the mannerism with which member A (i.e., the owner of the interactive device 100) interacts with member B (i.e., the boss of member A) and member C (i.e., a colleague of member A). Further, the learned information may be used to build the personality of the interactive device 100 by replicating a behavior which would be more acceptable while interacting with respective members present in different environments.

Further, the interactor 140 may interact with the user and the one or more identification information based authentication enabled devices based on the user profiles and the profiles of the one or more members, in addition to the relationship profile. The relationship profile may be generated by extracting common preferences from the user profile, the profiles of the one or more members and the behavior of the users when in company with one another.

For example, when a user is with one or more family members, the user may interact with the interactive device 100 and ask the interactive device 100 to play a song. The profile manager 120 may access the common relationship profile (i.e., the relationship profile of the user) from the profiles database 130 and determine the song based on different contextual parameters which are liked by all members of the family, and plays a song based on the contextual parameters.

The object identifier 150 can be configured to analyze the inputs received by the sensor 110 and identify various objects based on the analysis. The objects may include various objects present in the social environment such as electronic devices and furniture.

The interactive device 100 may be vulnerable to collisions with objects and/or obstacles present in the social environment. Hence, the object identifier 150 may be configured to identify the position and/or location of the objects and determine a path of motion, where the path of motion is determined by avoiding the obstacles. Further, the object identifier 150 may be configured to generate a zone map based on the various objects identified and by associating the users to the environment. Further, the zone map may be used to control various devices based on the learned information obtained from the interactor 140.

The processor 160 can be configured to interact with the hardware components such as the sensor 110, the profile manager 120, the profiles database 130, the interactor 140, the object identifier 150 and the memory 170 in the interactive device 100 for providing social interaction with the users.

The memory 170 may include cloud based or non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 170 may be considered a non-transitory storage medium. The term “non-transitory” may indicate that the storage medium is not embodied in a carrier wave or a propagated signal. However, the term “non-transitory” should not be interpreted that the memory 170 is non-movable. For example, the memory 170 can be configured to store larger amounts of information than the memory. In certain examples, a non-transitory storage medium may store data that can, over time, change (e.g., in random access memory (RAM) or cache).

Although FIG. 1A shows the hardware components of the interactive device 100, it is to be understood that other embodiments are not limited thereto. For example, the interactive device 100 may include additional components or may include less components. Further, the labels or names of the components are used only for illustrative purpose and do not limit the scope of the disclosure. One or more components can be combined together to perform the same or a substantially similar function for providing social interaction with the users in the interactive device 100.

FIG. 1B is a schematic illustrating the interaction between the various hardware components of the interactive device 100 for providing social interaction, according to an embodiment.

Referring to the FIG. 1B, the user identification information, such as the iris scan, may be acquired by the sensor 110 and advertised to the identification authentication enabled devices which are in proximity to the interactive device 100. The interactive device may use the obtained identification information to access the devices in proximity with the interactive device for obtaining a user profile. Further, the profile manager 120 may obtain the user profile information (i.e., data which includes profile information) from the device and infer the relationship of the user with the other members. The user profile information from the device may be used to generate the profile of the user and the other members related to the user. Further, the user profile information from the device may also be used to generate a common relationship profile. The user profile, the profile of the members related to the user and the relationship profile may be stored in the profile database 130.

The sensor 110 may provide data including information regarding the environment of the user, such as position/location information of objects or the user's location. The information regarding the environment of the user may be used by the object identifier 150 to generate the zone map which includes the path of motion for the interactive device 100 to avoid the obstacles and an association of the users with a specific area. Further, the data generated by the object identifier 150 may be stored in the profile database 130 as part of user profiles and the relationship profile.

Further, the data from the sensor 110 may also be used to monitor the behavior of the user and train the interactive device 100 to behave in a socially acceptable manner. The user profiles are continuously updated based on the learned information obtained from the interactor 140.

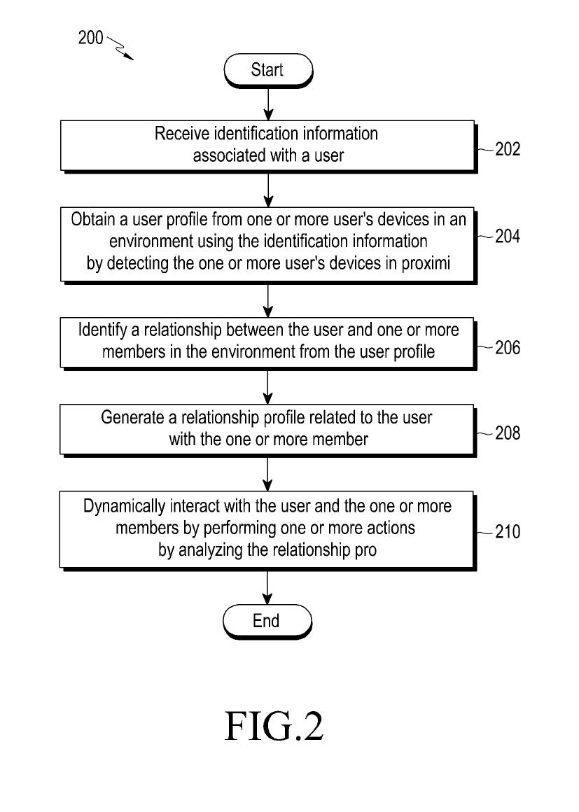

FIG. 2 is a flow chart 200 illustrating the method of providing social interaction by the interactive device 100, according to an embodiment.

Referring to FIG. 2, at step 202, the interactive device 100 receives identification information associated with the user. For example, in the interactive device 100 as illustrated in the FIG. 1A, the sensor 110 can be configured to receive the identification information associated with the user.

At step 204, the interactive device 100 obtains the user profile from one or more user devices in the environment using the identification information by detecting the one or more user devices in proximity with the interactive device 100. For example, in the interactive device 100 illustrated in the FIG. 1A, the profile manager 120 can be configured to obtain the user profile from one or more devices in the environment using the identification information by detecting the one or more user devices in proximity with the interactive device 100.

At step 206, the interactive device 100 identifies the relationship between the user and one or more members in the environment from the user profile. The interactive device 100 accesses the user's data and social media profile such as images, documents, SNS (social network services) profiles, contacts, and e-mail accounts which are related to the user and analyzes one or more members who frequently contact or frequently takes images with the user. The interactive device 100 deduces a relationship between the user and the one or more members based on the analysis. For example, in the interactive device 100 illustrated in the FIG. 1A, the profile manager 120 can be configured to deduce the relationship between the user and one or more members in the environment from the user profile.

At step 208, the interactive device 100 generates the relationship profile related to the user with the one or more members by obtaining the profile of the one or more members and determining common characteristics among the user and the one or more members. For example, in the interactive device 100 illustrated in the FIG. 1A, the profile manager 120 can be configured to generate the relationship profile related to the user with the one or more members by obtaining the profile of the one or more members and determining common characteristics among the user and the one or more members.

At step 210, the interactive device 100 dynamically interacts with the user and the one or more members by performing one or more actions by analyzing the relationship profile. For example, in the interactive device 100 as illustrated in the FIG. 1A, the interactor 140 can be configured to dynamically interact with the user and the one or more members by performing one or more actions by analyzing the relationship profile.

The various actions, acts, blocks, or steps in the method of FIG. 2 may be performed in the order presented, in a different order or simultaneously. Further, in some embodiments, some of the actions, acts, blocks, or steps may be omitted, added, modified, or skipped without departing from the scope of the disclosure.

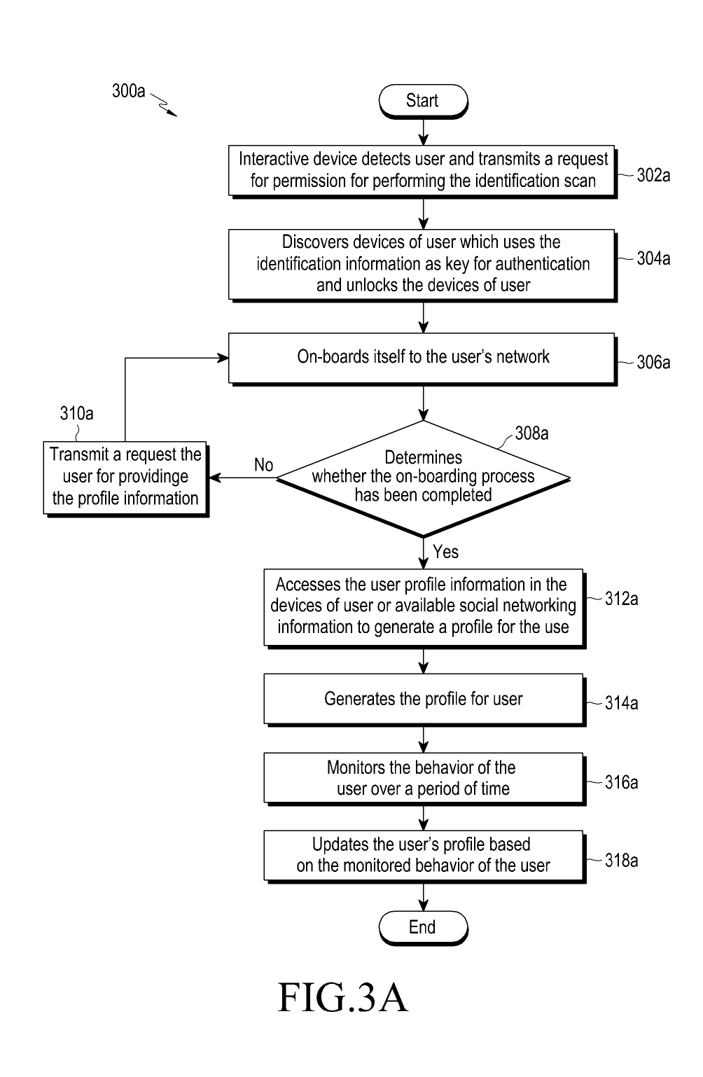

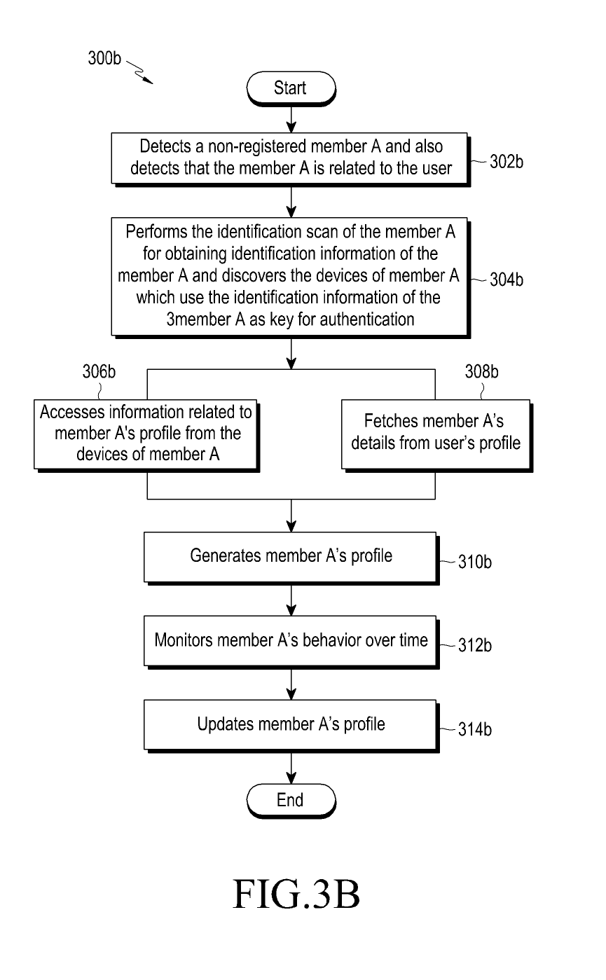

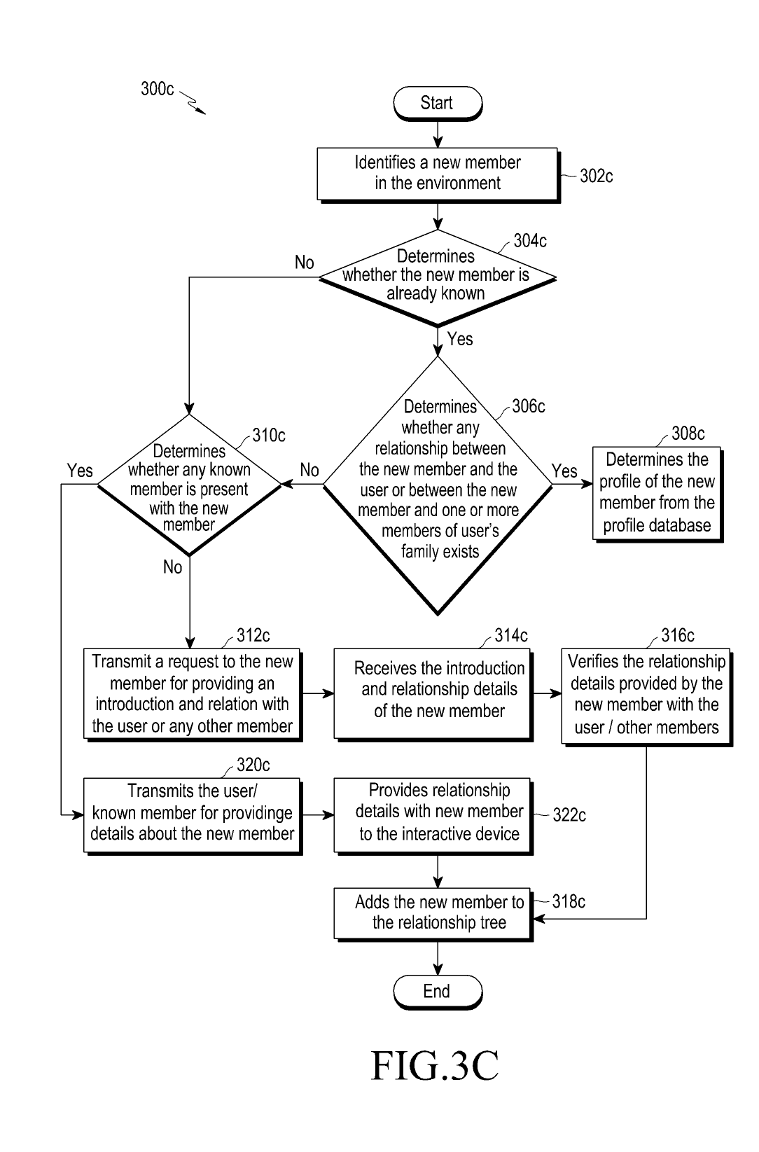

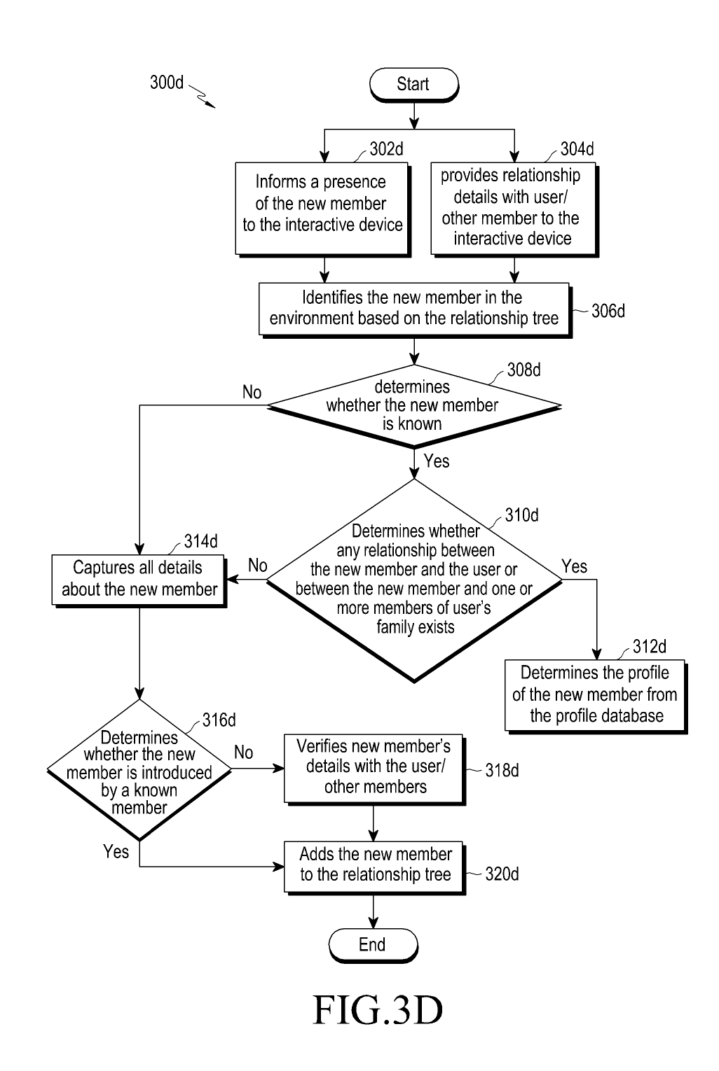

FIG. 3A is a flow chart 300a illustrating a method for on-boarding the interactive device 100 and creating a user profile, according to an embodiment.

Referring to the FIG. 3A, at step 302a, the interactive device 100 detects the user and transmits a request for permission for performing the identification scan (e.g., an iris scan) for obtaining identification information of the user (e.g. a user's iris information). For example, in the interactive device 100 illustrated in the FIG. 1A, the sensor 110 can be configured to detect the user and transmit a request for permission for performing the identification scan to obtain identification information of the user. The interactive device 100 may generate an iris code based on the received identification information.

At step 304a, the interactive device 100 discovers devices of the user which use the identification information as a key for authentication and unlocks the devices of user. The interactive device 100 performs a proximity scan to match the iris code over a service access point (SAP) connection or another connection type. The devices of the user receive the iris code and respond to the interactive device 100 after authenticating if the key and the iris code are matched. The user credentials of the interactive device 100 and the devices of the user are matched and verified. For example, in the interactive device 100 illustrated in the FIG. 1A, the sensor 110 can be configured to discover the devices of the user which use the identification information as a key for authentication and unlocks the devices.

At step 306a, the interactive device 100 on-boards itself to the user's network. Specifically, the interactive device 100 receives user details from the devices of users and on-boards itself based on the received user details. The interactive device 100 sets the user as an owner. For example, in the interactive device 100 illustrated in the FIG. 1A, the sensor 110 can be configured to on-board the interactive device 100 to the user's network.

At step 308a, the interactive device 100 determines whether the on-boarding process has been completed. For example, in the interactive device 100 illustrated in the FIG. 1A, the sensor 110 can be configured to determine whether the on-boarding process has been completed.

Upon determining that the on-boarding process has not been completed, at step 310a, the interactive device 100 transmits a request for the user to provide the profile information and loops to step 306a.

Upon determining that the on-boarding process has been completed, at step 312a, the interactive device 100 accesses the user profile information in the devices of the user or available social networking information of the user to generate a profile for the user. Specifically, the interactive device 100 accesses user information such as images, documents, SNS profiles, contacts, and e-mail accounts. In response to accessing the user information, the interactive device 100 obtains the user's relationship, the user's likes, places the user visited, locations of the user, occasions related to the user, sports related to the user, education related to the user, the user's relationships, the user's work, connections related to the user, and user preferences. For example, in the interactive device 100 illustrated in the FIG. 1A, the profile manager 120 can be configured to access the user profile information in the user's devices or available social networking information to build a profile for the user.

At step 314a, the interactive device 100 generates the profile for the user (i.e., the user's profile). For example, in the interactive device 100 illustrated in the FIG. 1A, the profile manager 120 can be configured to generate the profile for the user.

At step 316a, the interactive device 100 monitors the behavior of the user over a period of time. For example, in the interactive device 100 as illustrated in the FIG. 1A, the interactor 140 can be configured to monitor the behavior of the user over a period of time.

At step 318a, the interactive device 100 updates the user's profile based on the monitored behavior of the user. For example, in the interactive device 100 illustrated in the FIG. 1A, the profile manager 120 can be configured to update the user's profile based on the monitored behavior of the user.

The various actions, acts, blocks, or steps in the method of FIG. 3A may be performed in the order presented, in a different order or simultaneously. Further, in some embodiments, some of the actions, acts, blocks, or steps may be omitted, added, modified, or skipped without departing from the scope of the disclosure.

FIG. 3B is a flow chart 300b illustrating a method for automatically on-boarding one or more members related to the user and present in the environment of the interactive device 100, according to an embodiment.

Referring to the FIG. 3B, at step 302b, the interactive device 100 detects a non-registered member A and also detects that the member A is related to the user (i.e., the owner of the interactive device 100). For example, in the interactive device 100 illustrated in FIG. 1A, the sensor 110 can be configured to detect a non-registered member A and also detect that the member A is related to the user.

At step 304b, the interactive device 100 performs the identification scan (e.g., an iris scan) of the member A for obtaining identification information of the member A and discovers the devices of member A which use the identification information of the member A as a key for authentication. The interactive device 100 performs a proximity scan to match the iris code over an SAP connection or another type of connection. The devices of member A receive the iris code and respond to the interactive device 100 after authenticating if the key and the iris code are matched. The user credentials of the interactive device 100 and the devices of member A are matched and verified. For example, in the interactive device 100 illustrated in the FIG. 1A, the sensor 110 can be configured to perform the identification scan of the member A and discover the devices of member A which use the identification information as a key for authentication.

At step 306b, the interactive device 100 accesses information related to member A's profile from the devices of member A. For example, in the interactive device 100 illustrated in the FIG. 1A, the profile manager 120 can be configured to access information related to the member A's profile from the devices of member A.

At step 308b, the interactive device 100 fetches member A's details from the user's profile. For example, in the interactive device 100 as illustrated in the FIG. 1A, the profile manager 120 can be configured to fetch member A's details from the user's profile.

At step 310b, the interactive device 100 generates member A's profile. For example, in the interactive device 100 illustrated in the FIG. 1A, the profile manager 120 can be configured to generate member A's profile.

At step 312b, the interactive device 100 monitors member A's behavior over time. For example, in the interactive device 100 illustrated in the FIG. 1A, the interactor 140 can be configured to monitor member A's behavior over time.

At step 314b, the interactive device 100 updates member A's profile. For example, in the interactive device 100 illustrated in the FIG. 1A, the profile manager 120 can be configured to update the member A's profile.

The various actions, acts, blocks, or steps in the method of FIG. 3B may be performed in the order presented, in a different order or simultaneously. Further, in some embodiments, some of the actions, acts, blocks, or steps may be omitted, added, modified, or skipped without departing from the scope of the disclosure.

FIG. 3C is, a flow chart 300c illustrating a method for adding the new member identified by the interactive device 100 to a relationship tree, according to an embodiment.

Referring to the FIG. 3C, at step 302c the interactive device 100 identifies a new member in the environment. For example, in the interactive device 100 illustrated in the FIG. 1A, the sensor 110 can be configured to identify a new member in the environment.

At step 304c, the interactive device 100 determines whether the new member is already known (i.e., the interactive device 100 checks whether the new member's profile already exists in the profiles database 130) or whether the new member is part of any of the already existing profiles of members. For example, in the interactive device 100 illustrated in the FIG. 1A, the profile manager 120 can be configured to determine whether the new member is already known.

Upon determining that the new member is known, at step 306c, the interactive device 100 determines whether any relationship between the new member and the user or any relationship between the new member and one or more members of the user's family exists. For example, in the interactive device 100 illustrated in the FIG. 1A, the profile manager 120 can be configured to determine whether any relationship between the new member and the user or any relationship between the new member and one or more members of the user's family exists.

Upon determining that a relationship between the new member and the user or a relationship between the new member and one or more members of user's family exists, at step 308c, the interactive device 100 determines the profile of the new member from the profile database 130.

Upon determining that no relationship exists between both the new member and the user, and between the new member and one or more members of user's family, at step 310c, the interactive device 100 determines whether any known member is present with the new member. The interactive device 100 determines whether the user or the one or more members relate to the new member. Further, at step 304c when the interactive device 100 determines that the new member is not known, the interactive device 100 loops to step 310c.

Upon determining that no known user is present with the new member, at step 312c, the interactive device 100 transmits a request to the new member for providing an introduction and relation with the user or any other member (i.e., a request for describing a relationship between the new member and the user or between the new member and any other member). For example, in the interactive device 100 illustrated in the FIG. 1A, the interactor 140 can be configured to transmit a request to the new member for providing an introduction and relation with the user or any other member.

At step 314c, the interactive device 100 receives the introduction and relationship details of the new member. For example, in the interactive device 100 illustrated in the FIG. 1A, the interactor 140 can be configured to receive the introduction and relationship details of the new member.

At step 316c, the interactive device 100 verifies the relationship details provided by the new member with the user or with other members. For example, in the interactive device 100 illustrated in the FIG. 1A, the profile manager 120 can be configured to verify the relationship details provided by the new member with the user or other members.

At step 318c, the interactive device 100 adds the new member to a relationship tree. For example, in the interactive device 100 illustrated in the FIG. 1A, the profile manager 120 can be configured to add the new member to the relationship tree.

Upon determining that a known user is present with the new member, at step 320c, the interactive device 100 transmits the user/known member (i.e., profile information for the user/known member) for providing details about the new member.

At step 322c, the user/known member provides relationship details about the new member to the interactive device 100. Further, at step 318c, the interactive device 100 adds the new member to the relationship tree.

The various actions, acts, blocks, or steps in the method of FIG. 3C may be performed in the order presented, in a different order or simultaneously. Further, in some embodiments, some of the actions, acts, blocks, or steps may be omitted, added, modified, or skipped without departing from the scope of the disclosure.

FIG. 3D is a flow chart 300d illustrating a method for adding the new member to the relationship tree based on an introduction of the new member, according to an embodiment.

Referring to the FIG. 3D, at step 302d, the user/other member informs a presence of the new member to the interactive device 100. Alternatively, at step 304d, the new member provides relationship details about the user/other member to the interactive device 100.

At step 306d, the interactive device 100 identifies the new member in the environment based on the relationship tree. For example, in the interactive device 100 illustrated in the FIG. 1A, the sensor 110 can be configured to identify the new member in the environment.

At step 308d, the interactive device 100 determines whether the new member is known. For example, in the interactive device 100 illustrated in the FIG. 1A, the profile manager 120 can be configured to determine whether the new member is known.

Upon determining that the new member is known, at step 310d, the interactive device 100 determines whether any relationship between the new member and the user or any relationship between the new member and one or more members of the user's family exists. For example, in the interactive device 100 illustrated in the FIG. 1A, the profile manager 120 can be configured to determine whether there exists any relationship between the new member and the user or any relationship between the new member and one or more members of user's family.

Upon determining that a relationship between the new member and the user or a relationship between the new member and one or more members of the user's family exists, at step 312d, the interactive device 100 determines the profile of the new member from the profile database 130.

Upon determining that the relationship between the new member and the user does not exist and the relationship between the new member and one or more members of user's family does not exist, at step 314d, the interactive device 100 captures details about the new member, for example, by asking relevant questions to the member or by capturing image/video of the member. Also, upon determining that the new member is not known, the interactive device 100 loops to step 314d. For example, in the interactive device 100 illustrated in the FIG. 1A, the sensor 110 can be configured to capture details about the new member.

At step 316d, the interactive device 100 determines whether the new member is introduced by a known member. For example, in the interactive device 100 illustrated in the FIG. 1A, the profile manager 120 can be configured to determine whether the new member is introduced by a known member.

Upon determining that the new member is not introduced by a known member, at step 318d, the interactive device 100 verifies the new member's details with the user/other members. For example, in the interactive device 100 illustrated in the FIG. 1A, the profile manager 120 can be configured to verify the new member's details with the user/other members. Further, at step 320d, the interactive device 100 adds the new member to the relationship tree.

Upon determining that the new member is introduced by a known member, at step 320d, the interactive device 100 adds the new member to the relationship tree. For example, in the interactive device 100 illustrated in the FIG. 1A, the profile manager 120 can be configured to add the new member to the relationship tree.

The various actions, acts, blocks, or steps in the method of FIG. 3D may be performed in the order presented, in a different order or simultaneously. Further, in some embodiments, some of the actions, acts, blocks, or steps may be omitted, added, modified, or skipped without departing from the scope of the disclosure.

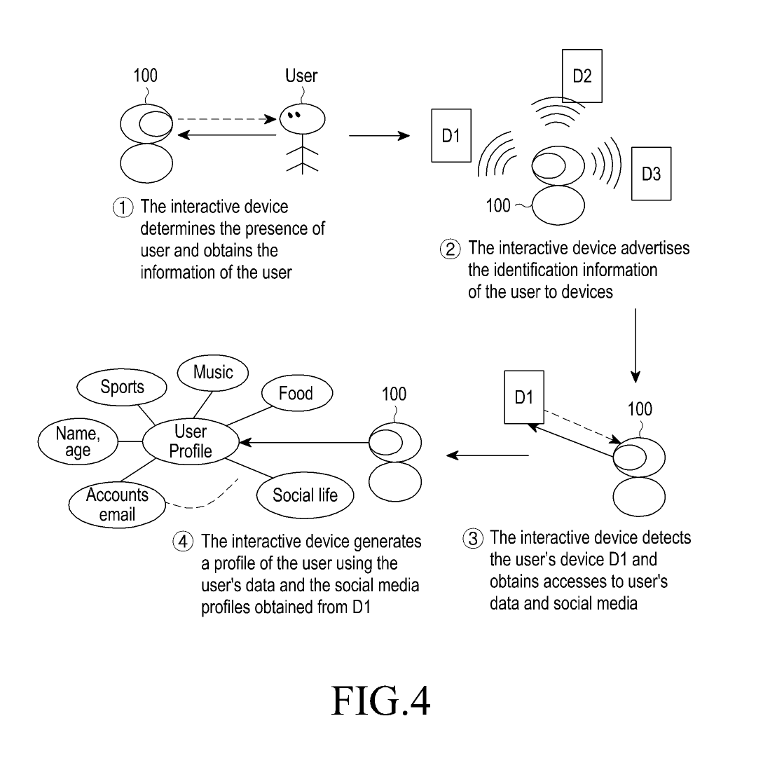

FIG. 4 illustrates a method for on-boarding the interactive device 100 and creating the user profile, according to an embodiment.

Referring to the FIG. 4, a scenario where the user (i.e., owner) unboxes and switches ON the interactive device 100 in the environment such as the house is provided.

At step 1, the interactive device 100 determines the presence of the user and obtains the identification information of the user (e.g. the user's iris information). At step 2, the interactive device 100 advertises the identification information of the user to external devices (i.e., D1, D2, and D3) within the proximity of the interactive device 100 and determines devices which of the devices use the identification information of the user as an authentication key.

At step 3, the interactive device 100 detects the user's device D1 and obtains access to the user's data and social media profiles in D1 such as images, documents, SNS profiles, contacts, and e-mail accounts which are related to the user.

At step 4, the interactive device 100 generates a profile of the user using the user's data and the social media profiles obtained from D1. The profile of the user includes details such as the user's contact details, pictures from the user's devices, details of favorite games, favorite restaurants, preferred music, appointments (i.e., reminders and to-do tasks), e-mail accounts, and friends of the user. Further, the interactive device 100 intelligently adds relationship details of the user based on the information obtained from D1 (e.g., the user's pictures, contacts and SNS relationship data).

A plurality of devices may use the same identification information for authentication. Hence, upon scanning for devices using the identification information, the interactive device 100 may obtain access to a large amount of information related to the user. The profile of the user may also include details related to other members of the user's family (i.e., the user's wife's details may be available in the user's profile) based on the information obtained from the user's devices.

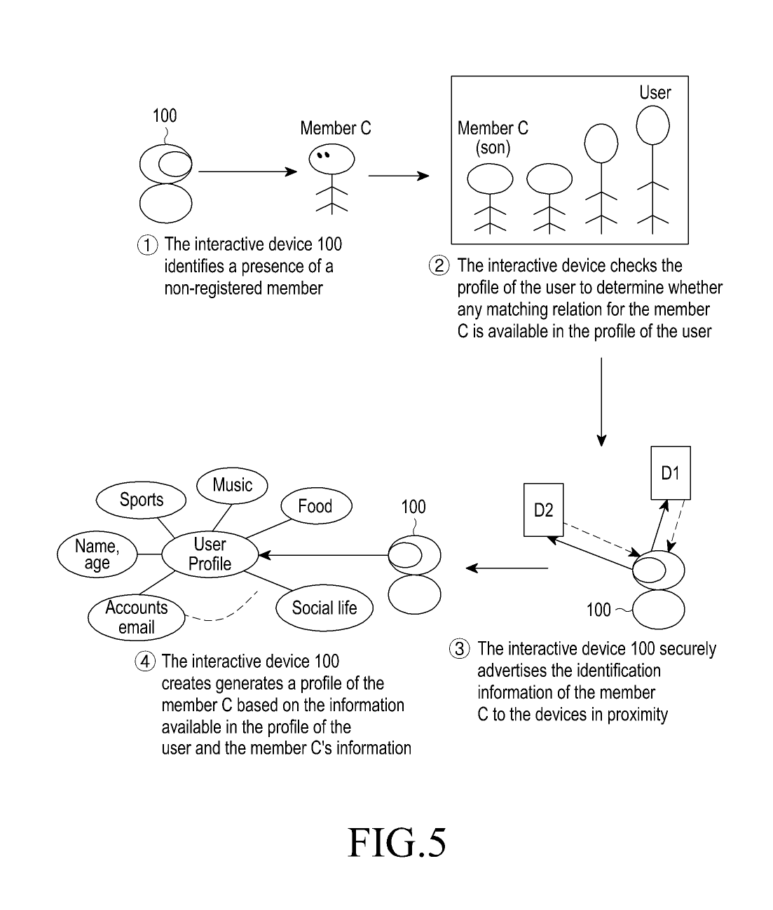

FIG. 5 illustrates a method for creating profiles for the one or more members related to the user, according to an embodiment.

Referring to FIG. 5, a scenario where the interactive device 100 is moving around the house and encounters a new member (i.e., member C) is provided. The interactive device 100 determines whether the new member is related to the user (i.e., the primary user of the interactive device 100) by checking the profile of the user.

At step 1, the interactive device 100 identifies a presence of a non-registered member (i.e., member C). For example, the interactive device 100 moves around a house of the user and detects a new face (e.g. the face of member C). At step 2, the interactive device 100 checks the profile of the user to determine whether any matching relation for the member C is available in the profile of the user. Further, the interactive device 100 determines, from the profile of the user, that member C is the son of the user and requests member C to provide identification information (e.g. iris information of member C). If member C does not approve of providing the identification information, the interactive device 100 creates a profile of the member C using only the information available in the profile of the user. If member C approves of providing the identification information, the interactive device 100 obtains the identification information of member C.

At step 3, the interactive device 100 securely advertises the identification information of member C to the devices in proximity to the interactive device 100. Further, the interactive device 100 may detect and unlock devices D1 and D2 to access the information regarding the member C. The information from devices D1 and D2 may include member C's information such as images, documents, SNS profiles, contacts, and e-mail accounts related to member C.

At step 4, the interactive device 100 generates a profile of the member C based on information available in the profile of the user and the information regarding member C retrieved from devices D1 and D2.

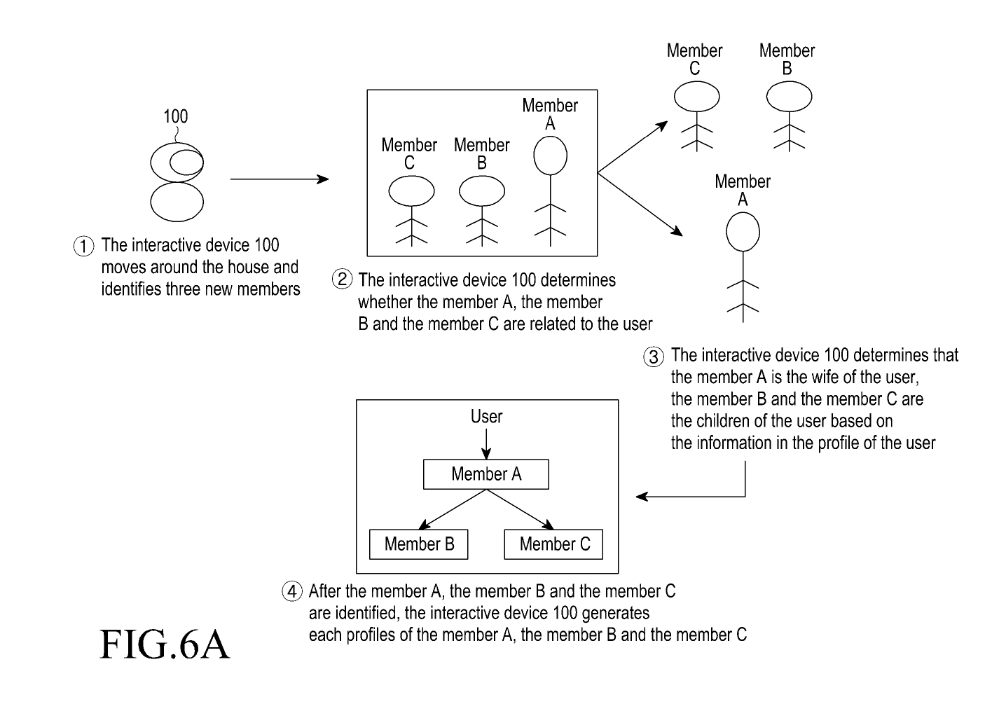

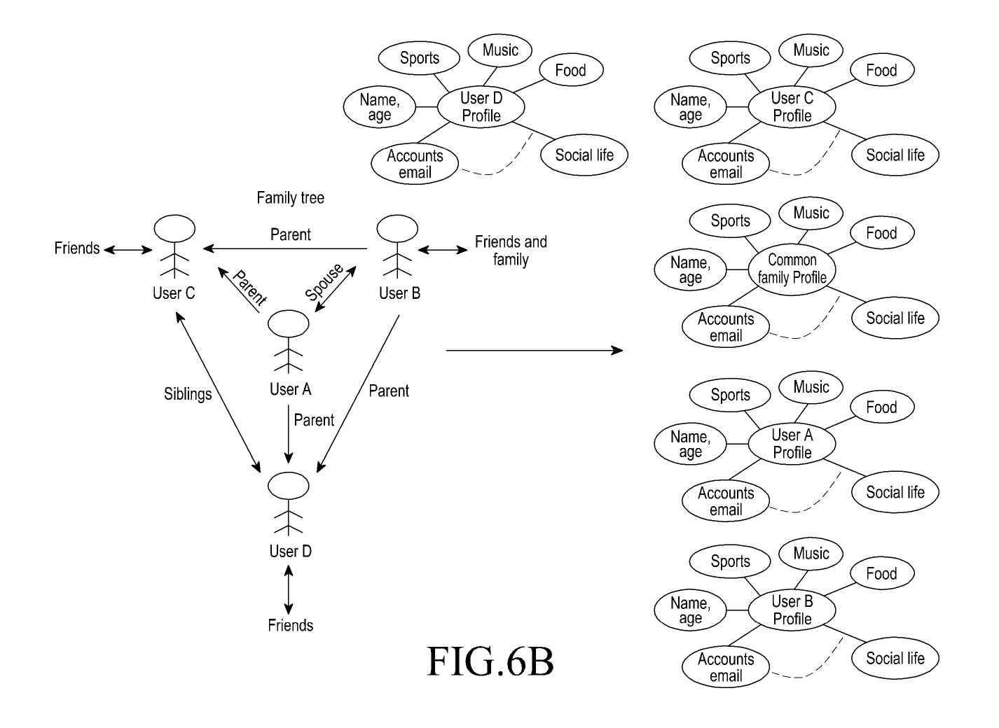

FIG. 6A illustrates a method for creating relationship profile for the family of the user, according to an embodiment.

Referring to FIG. 6A, at step 1, the interactive device 100 moves around the house and identifies three new members (i.e., member A, member B and member C).

At step 2, the interactive device 100 determines whether member A, member B and member C are related to the user by checking the profile of the user for a matching relationship of member A, member B and member C.

At step 3, the interactive device 100 determines that member A is the wife of the user and member B and member C are the children of the user based on the information in the profile of the user. Further, the interactive device 100 requests permission from member A, member B and member C to obtain the identification information (e.g. iris information of member A, member B and member C). Upon obtaining the permission to receive the identification information of member A, member B and member C, the interactive device 100 obtains the identification information of member A, member B and member C and advertises the identification information of the individual members to obtain access to devices in proximity to the interactive device 100.

The interactive device 100 may determine devices which use the identification information of member A, member B and/or member C as an authentication key among the devices. Further, the interactive device 100 may generate profiles of member A, member B and member C by accessing the information available in the devices of each of member A, member B and member C and the information available in the user's profile. The information available in the devices of each of member A, member B and member C may include images, documents, SNS profiles, contacts, and e-mail accounts related to member A, member B and member C.

At step 4, after member A, member B and member C are identified, the interactive device 100 generates profiles of member A, member B and member C. The interactive device 100 generates a family tree (as shown in FIG. 6B) based on the relationship of member A, member B and member C with the user.

FIG. 6B illustrates profiles for a family of the user, according to an embodiment.

The interactive device 100 monitors the behavior of member A, member B and member C and updates the details in the common family profile, as shown in FIG. 6B. For example, the user may like to listen to rock music when alone but may like to listen to melodious songs when with family. Hence, the common family profile will include melodious songs as the preferred music of the family but the user's preferred music will include rock music.

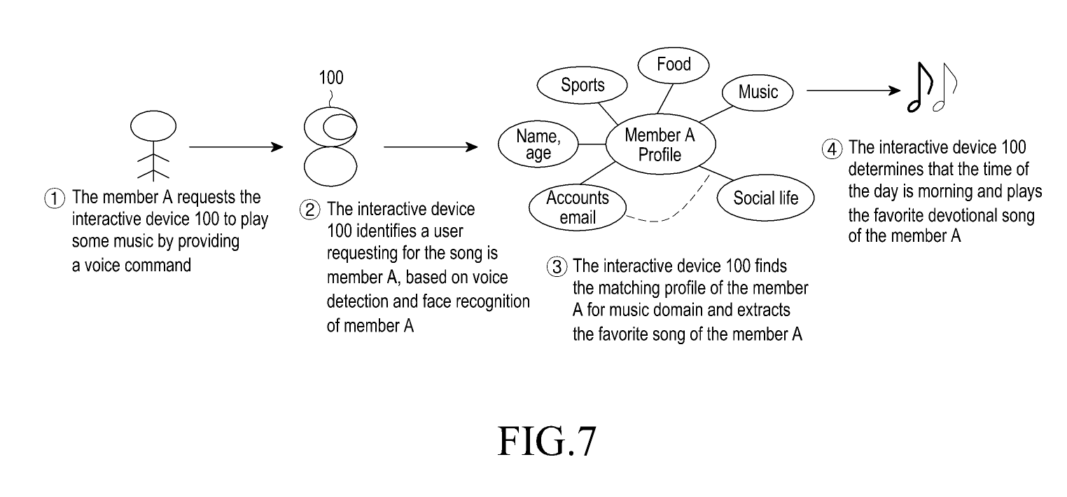

FIG. 7 illustrates a method for the user requesting the interactive device 100 to play music, according to an embodiment.

In the method, the user/members can request the interactive device 100 to play a favorite song or video without providing the favorite song or video. The interactive device 100 may identify the user/members, and select and play the favorite song from the user/member's profile, without requiring the user/members to provide the favorite song.

Referring to the FIG. 7, at step 1, the member A requests the interactive device 100 to play music by providing a voice command. At step 2, the interactive device 100 identifies that a user requesting the song is member A, based on voice detection and face recognition of member A. Further, the interactive device 100 also determines the environment of member A to determine if member A is alone or with other members of the family and other contextual parameters.

At step 3, the interactive device 100 finds the matching profile of the member A for a music domain and extracts the favorite song of member A based on factors such as other members present with member A, the time of the day, or a mood of member A. For example, member A may like to listen to a personal favorite devotional song early in the morning. At step 4, the interactive device 100 determines that the time of the day is morning and plays the favorite devotional song of the member A.

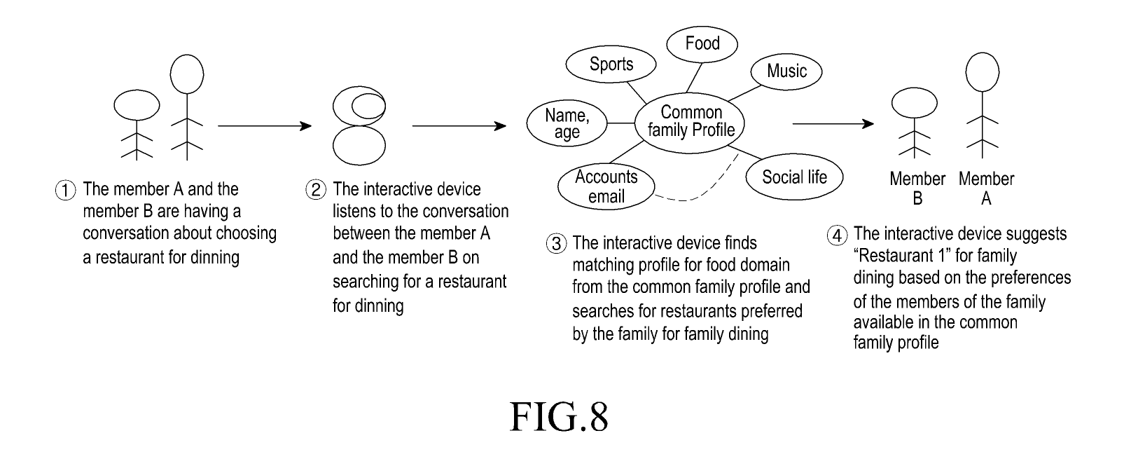

FIG. 8 illustrates a method for the interactive device 100 to help the members discover a restaurant based on a conversation, according to an embodiment.

Referring to FIG. 8, member A and member B are having a conversation about choosing a restaurant for dinning at step 1.

At step 2 the interactive device 100 listens to the conversation between member A and member B about choosing a restaurant for dinning. At step 3, the interactive device 100 finds a matching profile for a food domain from the common family profile and searches for restaurants preferred by the family for family dining. Further, the conversation may also include a specific type of food the family prefers, which can be noted by the interactive device 100. The interactive device 100 also updates information which is not previously available in the common family profile with information from the conversation based on the continuous learning.

At step 4, the interactive device 100 suggests a restaurant (i.e., “Restaurant 1”) for family dining based on the preferences of the members of the family available in the common family profile. Further, the interactive device 100 also provides details of the restaurant such as the restaurant menu, ratings, and reservation details to the members.

According to another embodiment, the interactive device 100 can provide suggestions to the user when the user queries the interactive device 100 for specific information. For example, the members can directly query the interactive device 100 to provide suggestions of restaurants for the family dinner.

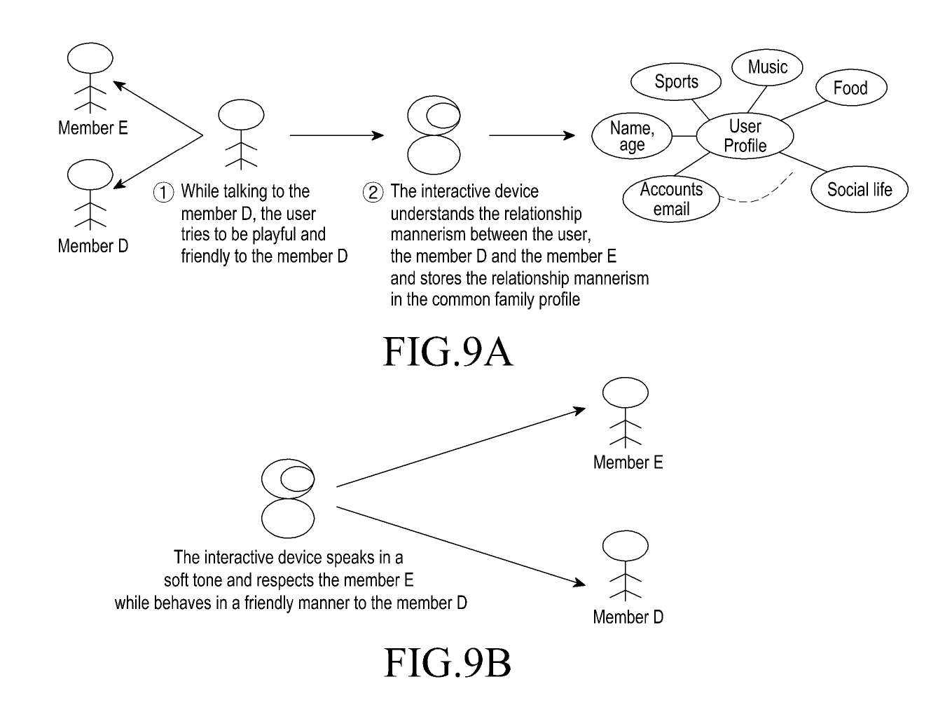

FIG. 9A illustrates a first method for providing the mannerism of the interactive device 100, according to an embodiment.

In conventional methods and systems, the interactive device 100 interacts with all people in a similar manner (i.e., the interactive device 100 communicates with all people with the same tone for conversation) or interacts with all people based on pre-programming of the interactive device 100 which is not a natural way of conversation. Unlike the conventional methods and systems, the interactive device 100 understands the social relationship between various users and interacts in a socially informed manner (i.e., the interactive device 100 shows respect to the elderly and/or attempts to be playful with kids) while conversing with a respective member.

Referring to the FIG. 9A, member E is the father of the user, and member D is the daughter of the user. While talking to member E, the user uses a soft tone and shows respect towards member E. While talking to member D, the user tries to be playful and friendly to member D, as seen at step 1.

At step 2, the interactive device 100 understands (i.e., determines) the relationship mannerism between the user, member D and member E and stores the relationship mannerism in the common family profile.

FIG. 9B illustrates a second method for providing the mannerism of the interactive device, according to an embodiment.

Referring to the FIG. 9B, the interactive device 100 interacts with each member according to the relationship mannerism stored in the common family profile. The interactive device 100 speaks in a soft tone and respects member E while behaving in a friendly manner towards member D. The feature of the interactive device 100 regarding understanding the relationship mannerism for all the members enables the interactive device 100 to be integrated into the family of the user.

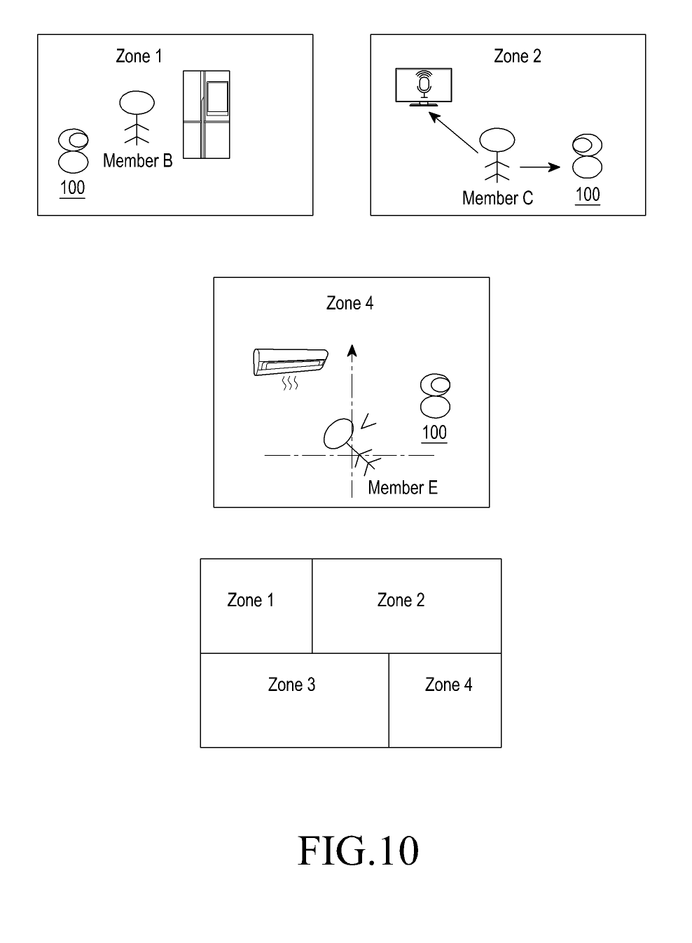

FIG. 10 illustrates a method for generating a map of the environment by the interactive device 100, according to an embodiment.

Referring to FIG. 10, member A is the wife of the user and spends most of her time cooking for the family in the kitchen. Member C is the son of the user and spends most of his time in the living room. The kitchen is named as zone 1. The interactive device 100 provides the particular user (i.e., member A) relative control of zone 1. For example, when member A says “turn on the exhaust fan”, the interactive device 100 determines the voice command to be that of member A, goes to zone 1 and turns on the exhaust fan in the zone 1.

Additionally, member E is the elderly father of the user spends most of his time resting in the bedroom, which is classified as zone 4. Further, when member E is out of zone 4, member E may provide the command of “turn off the lights in my room” to the interactive device 100 without mentioning the exact room. The interactive device 100 determines that the voice command is provided by member E based on face recognition, voice recognition, or other biometric data, recognizes that the user is member E and goes and turns off the lights of zone 4. Thus, personalized interaction with the interactive device 100 may be particularly helpful to communicate with people having disabilities or elderly people who need help.

Further, the interactive device 100 may generate a complete map based on the multiple zones present and store the complete map in the common family profile of the user.

According to another embodiment, the interactive device 100 may enter a room (i.e., zone 2) within the house environment and initiate a conversation with a registered member present in the room based on the profile of the member. For example, member C is the son of the user and has to get up early in the morning to study. The interactive device 100 may recognize the time that member C has to get up, provide an alarm at the set time and initiates a conversation with the member C, such as “Good morning. Would you like to have a cup of coffee?” in zone 2. The interactive device 100 may provide personalized information (i.e., preferences) of member C based on the profile of member C.

Accordingly, the interactive device 100 may improve social interaction.

Additionally, the interactive device 100 may provide on-boarding without user intervention by using identification information such as biometric information, a password, or any other security mechanism associated with the user.

In addition, the interactive device 100 may obtain user identification information scan for one or more user devices which are in proximity to the interactive device 100 using the identification information.

In addition, the interactive device 100 may generate a user profile using the information obtained from the user devices and to monitor user behavior to update the user profile.

In addition, the interactive device 100 may recognize one or more members in an environment and generate a relationship between the user and the one or more members from the user profile.

In addition, the interactive device 100 may generate a common relationship profile related to the user and the one or more members by determining common features from the user profile and the profile of the one or more members.

In addition, the interactive device 100 may dynamically interact with the user and the one or more members by performing an action based on an analysis of the relationship profile.

In addition, the interactive device 100 may monitor the behavior of the user and the one or more members with respect to the environment and generate a map of the environment by associating the user and the one or more members with the environment.

While the disclosure has been particularly shown and described with reference to certain embodiments thereof, it will be understood by those of ordinary skill in the art that various changes in form and details may be made therein without departing from the spirit and scope of the disclosure as defined by the appended claims and their equivalents.

What is claimed is:

1. A method of providing social interaction by an interactive device, the method comprising:
receiving identification information associated with a user;
obtaining a user profile from one or more devices of the user using the identification information by detecting the one or more devices of the user in proximity to the interactive device;
identifying a relationship between the user and one or more members related to the user from the user profile;
generating a relationship profile related to the user with the one or more members based on the identified relationship; and
interacting with the user and the one or more members by performing one or more actions by analyzing the relationship profile.

2. The method of claim 1, wherein interacting with the user and the one or more members further comprises:
detecting a presence of one of the user in proximity to the interactive device and the one or more members based on at least one of capturing audio, capturing video, viewing a human, or receiving a physical contact;
analyzing at least one of the captured audio, the captured video, the viewed human or the received physical contact based on the relationship profile; and
performing one or more actions in response to the analysis.

3. The method of claim 1, further comprising:
moving around an environment;
receiving identification information of the one or more members in response to encountering the one or more members; and
obtaining profiles of the one or more members from the one or more devices of the one or more members in proximity to the interactive device,
wherein the interactive device and the one or more devices are in the environment.

4. The method of claim 2, further comprising:
updating the user profile and one or more profiles of members by analyzing the at least one of the captured audio, the captured video, the viewed human or the received physical contact based on the relationship profile; and
interacting with the user and the one or more members based on the updated user profile and the updated one or more profiles of members.

5. The method of claim 3, further comprising:
updating the user profile and the one or more profiles of members by analyzing the at least one of the captured audio, the captured video, the viewed human or the received physical contact based on the relationship profile; and
interacting with the user and the one or more members based on the updated user profile and the updated one or more profiles of members.

6. The method of claim 1, wherein interacting with the user and the one or more members further comprises:
obtaining one or more images of an environment;
generating a map of the environment based on the obtained images;
receiving one or more commands from one of the user and the one or more members;
identifying the one or more devices operable to be controlled in the environment; and
controlling the identified one or more devices based on the one or more commands, wherein the interactive device and the one or more devices are in the environment.

7. The method of claim 4, further comprising:
classifying the environment into one or more zones based on one or more images of the environment;
identifying one or more activities of the user and the one or more members in the one or more zones; and
classifying the one or more zones based on the identified one or more activities of the user and the one or more members.

8. The method of claim 1, further comprising:
generating one or more new profiles of members for one or more new members detected in the environment by interacting with the one or more new members;
updating the relationship profile using the one or more new profiles of members; and
interacting with the one or more new members by performing one or more actions based on the relationship profile.

9. An interactive device for providing social interaction, the interactive device comprising:
a memory;
a processor coupled to the memory and configured to:
receive identification information associated with a user;
obtain a user profile from one or more devices of the user in an environment using the identification information by detecting the one or more devices of the user in proximity to the interactive device;
identify a relationship between the user and one or more members related to the user in the environment from the user profile;
generate a relationship profile related to the user with the one or more members based on the identified relationship; and
interact with the user and the one or more members by performing one or more actions by analyzing the relationship profile.

10. The interactive device of claim 9, wherein the processor is further configured to:
detect a presence of one of the user and one or more members in proximity to the interactive device based on at least one of capturing audio, capturing video, viewing a human, or receiving a physical contact;
analyze at least one of the captured audio, the captured video, the viewed human or the received physical contact based on the relationship profile; and
perform one or more actions in response to the analysis.

11. The interactive device of claim 9, wherein the processor is further configured to:
move around an environment;
receive identification information of the one or more members in response to encountering the one or more members; and
obtain one or more profiles of members from one or more devices of the one or more members in proximity,
wherein the interactive device and the one or more devices are in the environment.

12. The interactive device of claim 10, wherein the processor is further configured to:
update the user profile and the one or more profiles of members by analyzing the at least one of the captured audio, the captured video, the viewed human or the received physical contact based on the relationship profile; and
interact with the user and the one or more members based on the updated user profile and the updated one or more profiles of members.

13. The interactive device of claim 11, wherein the processor is further configured to:
update the user profile and the one or more profiles of members by analyzing the at least one of the captured audio, the captured video, the viewed human or the received physical contact based on the relationship profile; and
interact with the user and the one or more members based on the updated user profile and the updated one or more profiles of members.

14. The interactive device of claim 9, wherein the processor is further configured to:
obtain one or more images of an environment;
generate a map of the environment based on the obtained images;
receive one or more commands from one of the user and the one or more members;
identify one or more devices operable to be controlled in the environment; and
control the identified one or more devices based on the one or more commands, wherein the interactive device and the one or more devices are in the environment.

15. The interactive device of claim 12, wherein the processor is further configured to:
classify the environment into one or more zones based on the one or more images of the environment;
identify that the one or more zones are classified by identifying one or more activities of the user and the one or more members in the one or more zones; and
classify the one or more zones based on the identified one or more activities of the user and the one or more members.

16. The interactive device of claim 9, wherein the processor is further configured to:
generate one or more new profiles of members for one or more new members detected in the environment by interacting with the one or more new members;
update the relationship profile using the one or more new profiles of members; and
interact with the one or more new members by performing one or more actions based on the relationship profile.
